(19) United States
(12) Patent Application Publication
(10) Pub. No.: US 2016/0196743 A1
(43) Pub. Date: Jul. 7, 2016

(54) Automatic Responsive Sign Assembly

(71) Applicant: Marco Garcia, North Ridgeville, OH (US)

(72) Inventor: Marco Garcia, North Ridgeville, OH (US)

(21) Appl. No.: 14/989,952

(22) Filed: Jan. 7, 2016

Related U.S. Application Data
(60) Provisional application No. 62/100,625, filed on Jan. 7, 2015.

(51) Int. Cl. G08G 1/095; E01F 9/00

(52) U.S. Cl. CPC G08G 1/095; E01F 9/00

(57) ABSTRACT

Provided is a sign assembly for use in conjunction with a traffic signal. The sign assembly includes an internal power source for powering a lowering mechanism, such as a motor in driven connection with a pulley, and a sign lowering mechanism such as a standard stop sign. The sign assembly further includes a control circuit in electrical communication with the internal circuitry of the traffic signal having a sensor configured to monitor the traffic signal for power loss. The control circuit is configured to lower the stop sign when a loss of power to the traffic signal is detected and raise the stop sign when power is restored to the traffic signal. The stop sign reduces accident risk by reminding drivers to always stop at a four-way traffic signal intersection when the traffic signals lose power and become inoperable.

### CROSS REFERENCE TO RELATED APPLICATIONS

This application claims the benefit of priority under 35 U.S.C. §119(e) of U.S. Provisional Application No. 62/100,625 filed on Jan. 7, 2015, the disclosure of which is herein incorporated by reference in its entirety.

### BACKGROUND

The present disclosure relates to sign assemblies. More specifically, the present disclosure relates to sign assemblies having a sign that is deployable from a hidden stored position to a visible deployed position in order to reduce the risk of traffic accidents.

Traffic signals that include red, yellow, and green indicator lights are commonly utilized at four-way intersections to provide instructions for motorists when crossing an intersection in order to reduce the risk of traffic accidents. One drawback of traditional traffic signals is that they are typically hardwired to an electric grid and become inoperable when the grid loses power. Inoperable traffic signals are often overlooked or confronted incorrectly by motorists. A nonfunctioning traffic signal can cause serious vehicle accidents that require expensive repairs and may result in serious injury or even death. Therefore, there is a need for a corrective safety measure that is activated when a traffic signal loses power in order to prevent vehicle accidents.

When the traffic signals at a four-way intersection lose power and no longer function, motorists are lawfully required to treat the intersection as though it is a fourway stop sign, wherein each vehicle approaching the intersection must stop and wait for the intersection to clear before passing through. While this is intended to prevent accidents that may occur due to an inoperable traffic signal, many motorists are unaware of or simply ignore the law requiring them to treat the inoperable traffic signal as a four-way stop sign. Some motorists continue through the intersection without stopping, which can cause accidents that lead to injury or even death for vehicle occupants or pedestrians. It is therefore desirable to provide a safety device for reminding motorists to stop first when approaching an inoperable traffic light at a four-way intersection.

### SUMMARY

In view of the foregoing disadvantages inherent in the known types of traffic signals now present in the prior art, the present disclosure provides a sign assembly wherein the same can be utilized for providing a warning to motorists when a traffic signal loses power. The present system comprises a sign assembly having a housing with peripheral sidewalls that define an open interior volume. The present system further comprises a lowering mechanism such as a motor disposed within the housing in electrical communication with a power source, a pulley attached to a rotating drive shaft in driven connection with the motor, a length of material having proximate and distal ends, the proximate end attached to the pulley, and a sign attached to the distal end of the length of material. The present system additionally includes a control circuit having a sensor configured to monitor electrical power to a traffic signal, wherein the control circuit causes the sign to be lowered out of the open interior volume of the housing if a loss of power to the traffic signal is detected, and raised into the open interior volume of the housing if a return of power to the traffic signal is detected.

The present disclosure provides a sign assembly that decreases the risk of vehicle accidents by providing safety reminders and warnings to motorists. The present disclosure provides a sign assembly that provides a reminder to motorists to stop at an intersection having a nonfunctioning traffic signal.

The present disclosure further provides a method of manufacturing a sign assembly. The method includes the following steps: forming a housing having peripheral sidewalls that define an open interior volume; inserting a lowering mechanism within the interior of the housing and attaching the lowering mechanism to the interior of the housing; attaching a sign to the lowering mechanism; and connecting a control circuit to a sensor which is configured to monitor the flow of electrical power to a traffic light, and, connecting the control circuit to the lowering mechanism to allow the control circuit to electrically operate the lowering mechanism to lower the sign out of the open interior volume of the housing if a loss of electrical power to the traffic light is detected by the sensor. Also provided is a method of manufacturing a traffic light. The method includes the following steps: assembling a sign assembly comprising the following steps: forming a housing having peripheral sidewalls that define an open interior volume; inserting a lowering mechanism within the interior of the housing and attaching the lowering mechanism to the interior of the housing; attaching a sign to the lowering mechanism; and connecting a control circuit to a sensor which is configured to monitor the flow of electrical power to a traffic light, and, connecting the control circuit to the lowering mechanism to allow the control circuit to electrically operate the lowering mechanism to lower the sign out of the open interior volume of the housing if a loss of electrical power to the traffic light is detected by the sensor and, providing the traffic light; and electrically connecting the control circuit to the traffic light.

The present disclosure further provides a sign assembly attachable to a traffic signal. In certain embodiments, the sign assembly may have a control circuit connected to a traffic signal's integrated circuitry. The control circuit may be configured to monitor the electrical power to a traffic signal and deploy a sign if a power loss is detected. The sign assembly may also be configured to raise the sign to a hidden stored position when restoration of power to the traffic signal occurs.

### BRIEF DESCRIPTION OF THE DRAWINGS

Although certain features of the disclosed sign assembly are set forth in the claims, the following description and accompanying drawings provides an explanation of the general concept of the sign assembly and manner in which it may be made and used along with various exemplary embodiments.

FIG. 1 shows a front perspective view of an exemplary embodiment of a sign assembly secured to a traffic signal.

FIG. 2A shows a transparent view of an exemplary embodiment of a sign assembly with the sign in a deployed position.

FIG. 2B shows a transparent view of an exemplary embodiment of a sign assembly with the sign in a stored position.

FIG. 3 shows a flowchart detailing the operation of the control circuitry of an exemplary embodiment of a sign assembly.

FIG. 4 shows a side perspective view of an exemplary embodiment of a sign assembly.

### DETAILED DESCRIPTION

Referring now to the drawings wherein the showings are for purposes of illustrating embodiments of the sign assembly only and not for purposes of limiting the same, and wherein like reference numerals are understood to refer to or depict like components or similar elements of the sign assembly. The figures are intended for representative purposes only and should not be considered to be limiting in any respect.

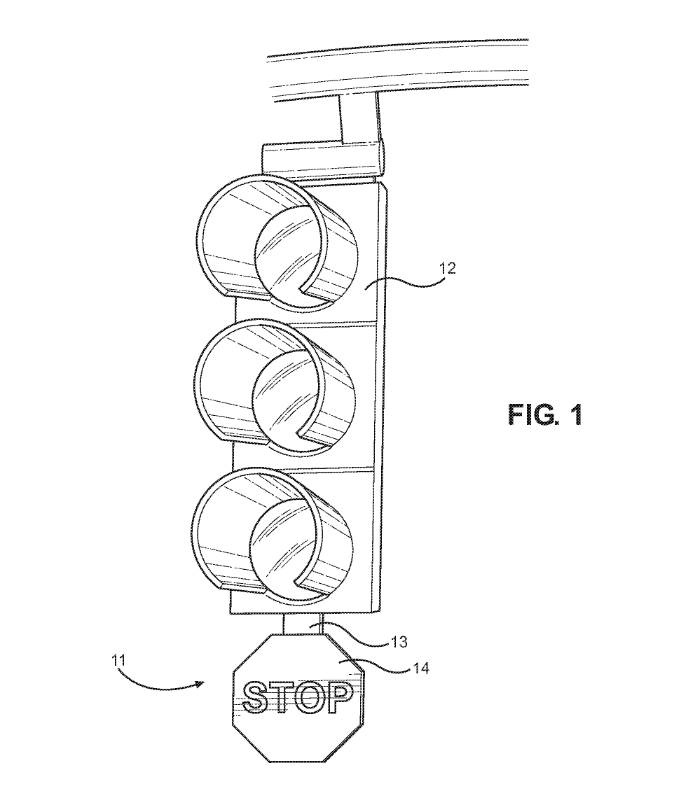

The sign assembly may be described as providing a warning for motorists when a traffic signal is inoperable. Referring now to FIG. 1, there is shown a front perspective view of an exemplary sign assembly according to the present disclosure secured to a traffic signal. The sign assembly 11 includes a sign 14 that may be raised or lowered from a hidden stored position via an attached length of material 13 which may also be referred to as an attaching member. The sign assembly 11 is securable to a rear portion of a traffic signal 12. The sign assembly 11 is configured to deploy the sign 14 when the traffic signal 12 loses electrical power and becomes inoperable.

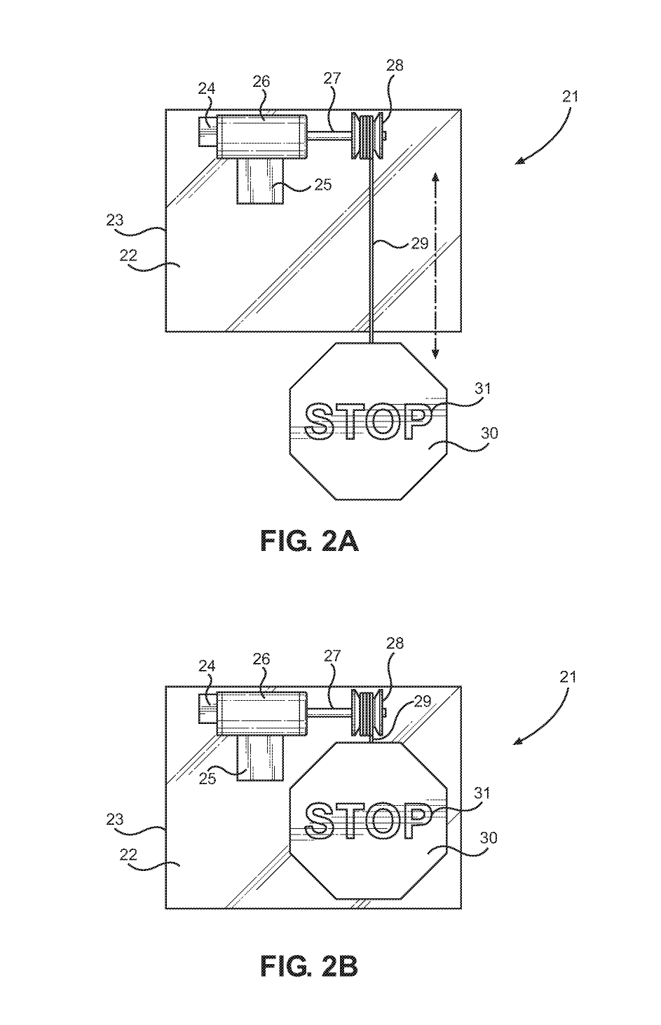

Referring now to FIG. 2A, there is shown a transparent view of a sign assembly according to the present disclosure with the sign in a deployed position. The sign assembly 21 comprises a housing 23 having peripheral edges that form an interior volume 22. A power source 24 is disposed within the interior volume 22 of the housing 23 and provides electrical power to the components of the sign assembly 21. In some embodiments, the power source 24 may be connected to a solar cell in order to provide energy to the power source 24. Alternatively, the power source 24 may be any suitable discrete power source such as a battery or rechargeable cell. A control circuit 25 is connected to the power source and is configured to integrate with the circuitry of a traffic signal and cause a sign 30 to be deployed from the housing 23 in the event the traffic signal loses power. The control circuit 25 may comprise various sensors such as a voltmeter, ammeter, or inductor in order to detect the voltage or current being supplied to the traffic signal.

The power source 24 is in electrical and operable communication with a lowering mechanism, such as motor 26, which may also be disposed within the interior volume 22 of the housing 23. A driveshaft 27 having proximate and distal ends is rotatably attached to the motor 26 at the proximate end such that the driveshaft is in driven connection with the motor 26. In certain embodiments, a pulley 28 is fixedly mounted to the distal end of the driveshaft 27 such that rotation of the driveshaft 27 causes rotation of the pulley 28. In embodiments including a pulley, a length of material 29 having proximate and distal ends is attached at its proximate end to a center portion of the pulley 28. In certain embodiments, the length of material 29 may be referred to as a length of coiled material, a length of winding material or a winding. The length of material 29 may be any suitably durable material such as metal, plastic, nylon, etc. and may be any suitable shape, such as a wire, planar strip, or tubular structure, in order to support the length of material 29 as it is wrapped around the circumference of the pulley 28. In certain embodiments, the length of material 29 may be a flexible material that may wind around the pulley 28 such as a rope, string, strap, wire, etc. In certain embodiments, the length of material 29 may be stranded (i.e., it may consist of twisted or plaited interlaced strands of flexible material) while in other embodiments, the length of material 29 may be non-stranded. In embodiments, which do not include a pulley, a system of levers and hinges may be used to raise and lower the sign assembly. In such embodiments, the sign assembly may be connected to the lowering mechanism through a non- flexible member. In further embodiments, the lowering mechanism of the sign assembly may include a manual mechanism for lowering and raising the sign assembly in addition to or as an alternative to a motor. Such embodiments may provide an alternative means for lowering and raising the sign assembly in case of a disruption in power to the motor, if present.

A sign 30 is attached to the distal end of the length of material 29. The sign 31 comprises indicia 31 disposed on a surface thereof In one embodiment, a portion of the sign 30 comprises the word ‘stop’ disposed thereon, and the sign 30 is octagonal in shape such that it resembles a standard stop sign. It should be understood, however, that any type, size, shape of traffic sign may be used with the sign assembly. When utilizing a standard stop sign for the sign 30, motorists are reminded to treat a four-way signal intersection as a four-way stop sign intersection when the traffic signals are nonfunctioning. In alternative embodiments, other shapes and sizes may be utilized for the sign 30, as well as other indicia 31, in order to provide different types of warning messages to motorists. Therefore, although the sign 30 is occasionally referred to herein as a stop sign, it should be understood that other types of traffic signs may be used within the sign assembly.

Referring now to FIG. 2B, there is shown a transparent view of a sign assembly according to the present disclosure with the sign in a stored position. The control circuit 25 is configured to control the position of the sign 30. When a traffic signal to which the sign assembly 21 is attached is receiving electrical power and functioning normally, the sign 30 remains hidden within the housing 23, as shown in FIG. 2B. When a traffic signal loses power and fails to function, the sign 30 is lowered out of the interior volume 22 of the housing 23 to a deployed position where it is visible to motorists, as shown in FIG. 2A.

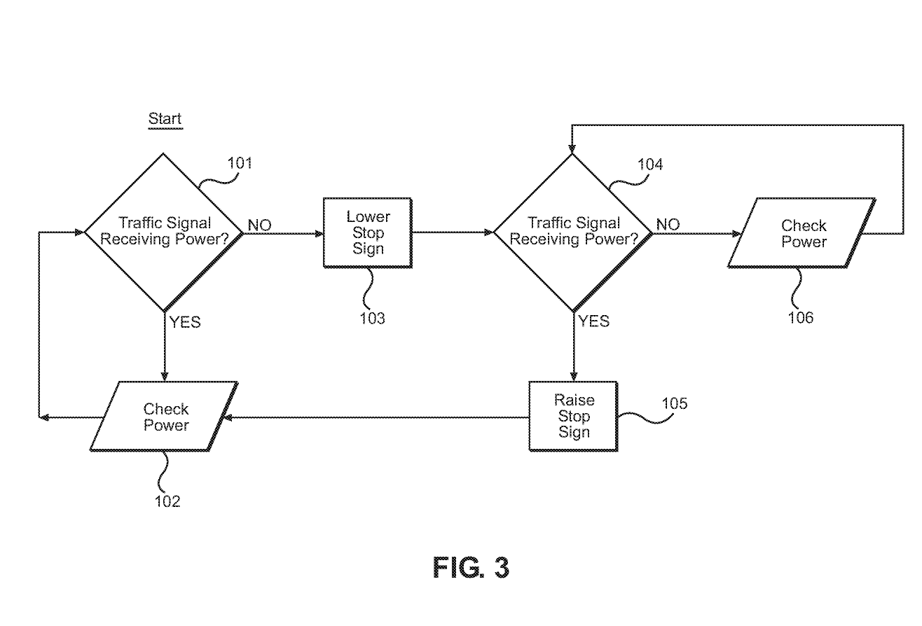

Referring now to FIG. 3, there is shown a flowchart detailing the operation of the control circuitry of a sign assembly according to the present disclosure. The control circuit integrates with a traffic signal's internal circuitry in order to constantly monitor whether the traffic signal is receiving electrical power. In order to accomplish this, the control circuit first determines 101 whether the traffic signal is receiving power by monitoring the electrical activity of the traffic signal's internal circuitry. The control circuit may utilize various sensors such as an ammeter to measure the current or a voltmeter to measure the voltage flowing to the traffic signal, which determines whether the traffic signal is operable. If the sensor detects that the traffic signal is receiving power, then the control circuit loops and continuously checks 102 the power status of the traffic signal. If it is determined 101 that the traffic signal is not receiving power, then the control circuit causes the motor to actuate and lower 103 the stop sign.

After the stop sign is lowered 103, the control circuit determines 104 whether power has been restored to the traffic signal. If the sensor is unable to sense a voltage or current, or if the control circuit determines 104 that the traffic signal power has not yet been restored, then the control circuit loops and continuously checks 106 the traffic signal in order to monitor for a restoration of power thereto. If the control circuit determines 104 that the traffic signal is once again receiving power, then the control circuit causes the motor to actuate in a reverse direction and raise 105 the stop sign back into the interior volume of the housing where it is obscured from view. After the stop sign is raised 105, the control circuit again checks 102 the status of the traffic signal and returns to continuously monitor the electrical power flowing thereto. In this way, the of the control circuit continuously monitors the electrical power of the traffic signal via sensors such as a voltmeter or ammeter, and causes a sign to be deployed when power is lost and raised when power is restored.

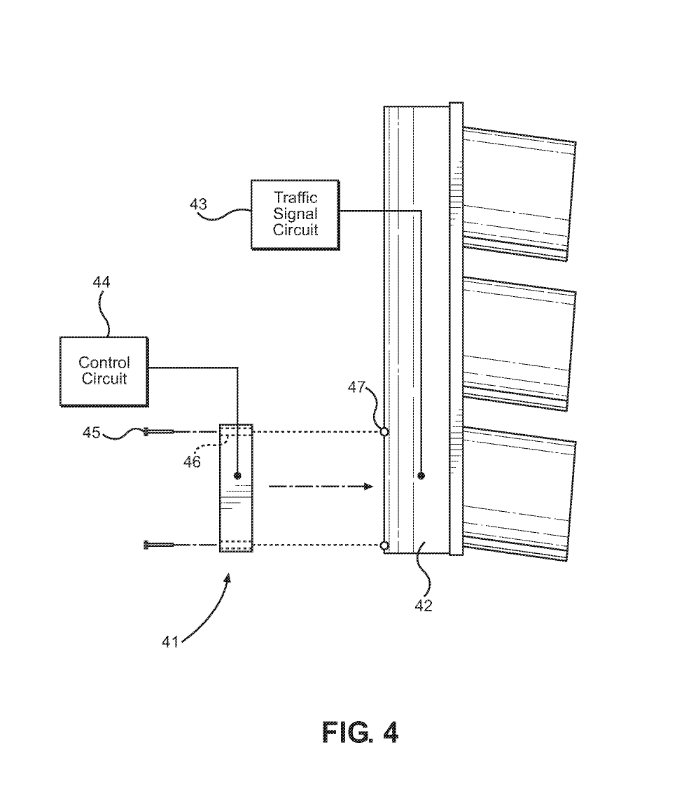

Referring now to FIG. 4, there is shown a side perspective view of a sign assembly according to the present disclosure. The sign assembly 41 further comprises one or more mounting apertures 46 that accept a fastener 45 therethrough in order to secure the sign assembly 41 to a traffic signal 42. Corresponding apertures 47 for receiving the fasteners 45 may be drilled through the housing of a standard traffic signal 42. The fasteners 45 may be a screw, nut and bolt, or other fastener configured to secure the sign assembly 41 to the traffic signal. The housing sign assembly may comprise additional apertures for connecting the control circuit 44 of the sign assembly 41 to the internal circuitry 43 of the traffic signal 42. In further embodiments, however, it should be understood that the sign assembly may be constructed as an integral component of a traffic signal.

While the sign assembly has been described above in connection with various illustrative embodiments, it is to be understood that other similar embodiments may be used or modifications and additions may be made to the described embodiments for performing the same function disclosed herein without deviating therefrom. Further, all embodiments disclosed are not necessarily in the alternative, as various embodiments may be combined or subtracted to provide the desired characteristics. Variations can be made by one having ordinary skill in the art without departing from the spirit and scope hereof. Therefore, the sign assembly should not be limited to any single embodiment, but rather construed in breadth and scope in accordance with the recitations of the appended claims.

Therefore, the foregoing is considered as illustrative only of the principles of the present disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the invention.

What is claimed is:

1) A sign assembly, comprising:
a housing having peripheral sidewalls that define an open interior volume;
a lowering mechanism;
a sign attached to the lowering mechanism; and
a control circuit comprising a sensor configured to monitor the flow of electrical power to a traffic light, wherein the control circuit causes the lowering mechanism to actuate and lower the sign out of the open interior volume of the housing if a loss of electrical power to the traffic light is detected by the sensor.

2) The sign assembly of claim 1, wherein the lowering mechanism is in operative and in electrical communication with a power source.

3) The sign assembly of claim 2, wherein the lowering mechanism can operate to raise the sign.

4) The sign assembly of claim 3, wherein the control circuit is further configured to cause the lowering mechanism to actuate and raise the sign into the open interior volume of the housing if a return of power to the traffic light is detected by the sensor.

5) The sign assembly of claim 1, wherein the control circuit sensor is a voltmeter.

6) The sign assembly of claim 1, wherein the control circuit sensor is an ammeter.

7) The sign assembly of claim 1, wherein the lowering mechanism comprises:
a motor in operable and electrical communication with the power source;
a driveshaft rotatably attached to the motor and in driven connection therewith;
a pulley attached to the driveshaft at an end opposing the motor;
a length of material having a distal end and a proximal end attached to the pulley at the proximal end;
wherein the sign is attached to the distal end of the length of material.

8) The sign assembly of claim 1, wherein the lowering mechanism comprises a manual mechanism for moving the sign out of the housing.

9) The sign assembly of claim 7, wherein the lowering mechanism further comprises a manual mechanism for moving the sign out of the housing in the case of a disruption of power to the motor.

10) The sign assembly of claim 1, wherein the housing is an integral component of a traffic signal.

11) The sign assembly of claim 1, wherein the housing further comprises one or more mounting apertures for accepting one or more fasteners therethrough for securing the sign assembly to a surface.

12) The sign assembly of claim 11, wherein the housing is secured to a traffic signal having internal circuitry via the one or more fasteners.

13) The sign assembly of claim 1, wherein the control circuit is in operable and electrical communication with the internal circuitry of the traffic signal.

14) The sign assembly of claim 1, wherein the power source comprises one or more batteries disposed within the housing.

15) The sign assembly of claim 1, wherein the one or more batteries are electrically connected to a solar cell disposed on an outer surface of the housing.

16) The sign assembly of claim 1, wherein the sign comprises indicia disposed on an outer surface thereof.

17) The sign assembly of claim 1, wherein the sign is an octagonal stop sign.

18) A method of manufacturing a sign assembly comprising
forming a housing having peripheral sidewalls that define an open interior volume;
inserting a lowering mechanism within the interior of the housing and attaching the lowering mechanism to the interior of the housing;
attaching a sign to the lowering mechanism; and
connecting a control circuit to a sensor which is configured to monitor the flow of electrical power to a traffic light, and,
connecting the control circuit to the lowering mechanism to allow the control circuit to electrically operate the lowering mechanism to lower the sign out of the open interior volume of the housing if a loss of electrical power to the traffic light is detected by the sensor.

19) A method of manufacturing a traffic light comprising:
assembling a sign assembly comprising the following steps:
forming a housing having peripheral sidewalls that define an open interior volume;
inserting a lowering mechanism within the interior of the housing and attaching the lowering mechanism to the interior of the housing;
attaching a sign to the lowering mechanism; and
connecting a control circuit to a sensor which is configured to monitor the flow of electrical power to a traffic light, and,
connecting the control circuit to the lowering mechanism to allow the control circuit to electrically operate the lowering mechanism to lower the sign out of the open interior volume of the housing if a loss of electrical power to the traffic light is detected by the sensor and, providing the traffic light; and
electrically connecting the control circuit to the traffic light.
